(19) United States
(12) Patent Application Publication
(10) Pub. No.: US 2017/0305070 A1
(43) Pub. Date: Oct. 26, 2017

(54) MANUFACTURING SYSTEM IMPLEMENTING LASER-CURING OF EPOXIED JOINTS

(71) Applicant: Faraday&Future Inc., Gardena, CA (US)

(72) Inventors: John Arthur Hirshey, III, Bloomfield Hills, MI (US); Marco Busiello, Torrance, CA (US)

(21) Appl. No.: 15/498,368

(22) Filed: Apr. 26, 2017

Related U.S. Application Data
(60) Provisional application No. 62/327,786, filed on Apr. 26, 2016.

(51) Int. Cl. B29C 65/16; B29C 65/48; B29C 65/00; B62D 27/02; B62D 65/02; B29L 31/30

(52) U.S. Cl. CPC B29C 65/16; B29C 66/80; B62D 27/026; B29C 65/4805; B29L 2031/30; B62D 65/02; B60Y 2304/05

(57) ABSTRACT

A manufacturing system may include at least one clamp configured to maintain a distance of separation between a first component and a second component for an epoxy provided therebetween. The manufacturing system may also include a laser, and a controller in communication with the laser. The controller may be configured to cause the laser to direct at least one light beam against one of the first and second components to heat the epoxy by conduction to a cure temperature.

### CROSS-REFERENCE TO RELATED APPLICATIONS

This application claims the benefit of U.S. Provisional Application No. 62/327,786, filed Apr. 26, 2016, the entirety of which is hereby incorporated by reference.

### TECHNICAL FIELD

The present disclosure relates generally to a manufacturing system, and more particularly, to a manufacturing system implementing laser-curing of epoxied joints.

### BACKGROUND

Welding is the process of joining two components (typically metals or thermoplastics) through the localized application of high heat. In some instances, the base materials of the components are melted when exposed to the heat, causing the components to fuse directly to each other. In other instances, the heat causes a filler material to be melted within a joint between the components. Upon cooling, the melted materials harden to form a solid connection. One common method of welding is known as Laser Beam Welding (LBW), wherein the heat used to melt the materials is generated by a laser. Although welding can be effective, the high temperatures required to melt the materials can cause undesired property changes and/or distortion within the materials.

An alternative method of joining two components involves the use of a heat-cured epoxy. In particular, an epoxy can be applied between two components to be joined. The components are then mechanically connected to each other (e.g., via rivets), and the resulting assembly is placed inside an oven and heated above a cure temperature of the epoxy. In some instances, the assembly must be held at the elevated temperature for a specified period of time before curing is complete. Although the cured joint can be used as an alternative to a fused joint, the conventional use of heat-cured epoxies can be time consuming, complex, and expensive.

The disclosed manufacturing system is directed to mitigating or overcoming one or more of the problems set forth above and/or other problems in the prior art.

### SUMMARY

One aspect of the present disclosure is directed to a manufacturing system. The manufacturing system may include at least one clamp configured to maintain a distance of separation between a first component and a second component for an epoxy provided therebetween. The manufacturing system may also include a laser, and a controller in communication with the laser. The controller may be configured to cause the laser to direct at least one light beam against one of the first and second components to heat the epoxy by conduction to a cure temperature.

Another aspect of the present disclosure is directed to a method of manufacture. The method may include providing a quantity of an epoxy in a space between a first component and a second component with an epoxy. The method may also include directing a light beam against at least one of the first and second components to heat the epoxy by conduction to a cure temperature.

Yet another aspect of the present disclosure is directed to an automotive body. The automotive body may include a first body panel having a first flange, and at least one of a second body panel and a frame having a second flange. The automotive body may also include a heat-cured epoxy sandwiched between the first and second flanges. The first and second flanges may be connected to each other by only the heat-cured epoxy.

### BRIEF DESCRIPTION OF THE DRAWINGS

FIG. 1 is a perspective illustration of an exemplary disclosed manufacturing system.

FIG. 2 is a perspective illustration of an exemplary disclosed joint that may be produced by the manufacturing system of FIG. 1.

FIG. 3 is a flowchart illustrating an exemplary process that may be performed by the manufacturing system of FIG. 1.

### DETAILED DESCRIPTION

The disclosure is generally directed to a manufacturing system that may reduce a time, complexity, and/or cost of joining two or more components to each other. In some embodiments, the manufacturing system may be used to join components of an automobile, for example body panels of a car. The system may utilize a laser heat source to cure an epoxy located between the components (e.g., between flanges of the components). Once the epoxy is cured, the components may be rigidly connected to each other at the flanges via only the epoxy. The heat provided by the laser heat source to cure the epoxy may be low enough to ensure that material properties of the components are substantially unaffected.

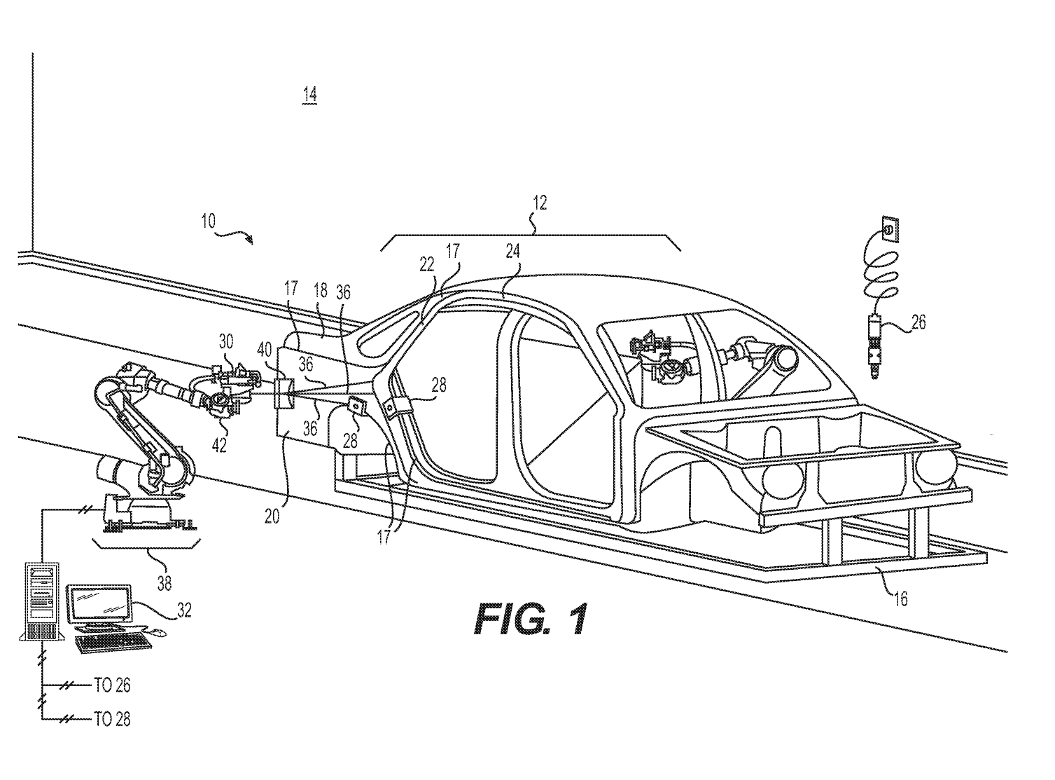

FIG. 1 is a perspective illustration of an exemplary manufacturing system 10 that can be used to fabricate an automobile 12. Although automobile 12 is shown as a car in FIG. 1, it is contemplated that automobile 12 may alternatively be a pickup truck, a motorcycle, a utility vehicle, a van, or any other type of automobile known in the art. Manufacturing system 10 may be used to permanently join two or more components of automobile 12 to each other. Manufacturing system 10 may also be used to join non-automobile components to each other, if desired.

In the exemplary embodiment depicted in FIG. 1, system 10 is included within a body station 14 of an assembly line at a factory. Specifically, automobile 12 may be mounted to a fabrication platform 16, which functions to transport automobile 12 between different stations (e.g., from body station 14, to a paint station, to an interior station, to a powertrain station, etc.) at the factory. And as automobile 12 enters body station 14, system 10 may be configured to automatically create rigid joints 17 at predefined locations between the components of automobile 12. For example, manufacturing system 10 may be used to join a first body panel 18 to a second body panel 20 and/or to a frame member 22 by creating rigid joints 17 therebetween. Manufacturing system 10 may also or alternatively be used to join frame member 22 to another frame member 24 or to any other component of automobile 12. The components of automobile 12 that are joined via manufacturing system 10 may be fabricated from similar materials (e.g., from aluminum) or from dissimilar materials (e.g., aluminum, plastic, carbon fiber, and steel).

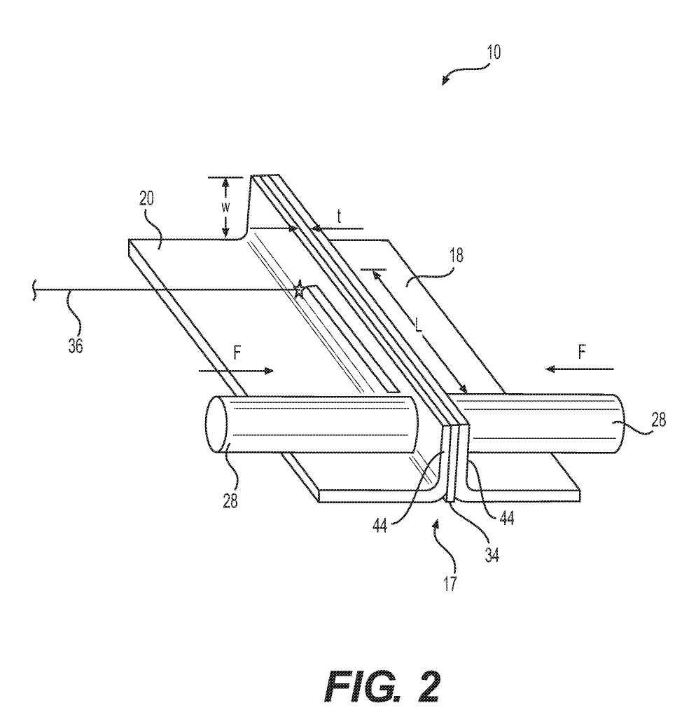

Manufacturing system 10 may include multiple parts that cooperate to create joints 17 between the components (e.g., between first and second body panels 18 and 20) of automobile 12. These parts may include, among other things, an epoxy dispenser 26, one or more clamps 28, a laser 30, and a controller 32. As will be explained in more detail below, epoxy dispenser 26 may be manually and/or automatically operated to place a layer of epoxy 34 (shown only in FIG. 2) within a space between the components of automobile 12; clamp(s) 28 may cause the components of automobile 12 to sandwich epoxy 34; laser 30 may generate one or more light beams 36 that heat epoxy 34 to a cure temperature while the components and epoxy 34 are held by clamp(s) 28; and controller 32 may regulate operation of epoxy dispenser 26, clamp(s) 28, and/or laser 30.

Epoxy 34 may be manually or automatically applied to the components of automobile 12 as either a liquid or a soft solid (e.g., a paste or a gel). For example, epoxy 34 may be painted on one or both of the components using dispenser 26, sprayed from dispenser 26 onto the components, squeezed out of dispenser 26 into the joint space between the components, or applied in some other manner. Epoxy 34 may be a heat-cured type of adhesive made from a thermosetting polymer, and curing of epoxy 34 may be completed more efficiently when a temperature of epoxy 34 is maintained at an elevated cure temperature for a specific period of time. According to some embodiments, the cure temperature is less than about ⅓ (e.g., within 10%) of a lowest melting temperature of the components being joined by epoxy 34, with the specific period of time being reduced for higher cure temperatures. For example, when the components being joined are fabricated from aluminum or an aluminum alloy having a melting temperature of about 450-700° C., the cure temperature of epoxy 34 may be about 150-233° C., and the specific period of time may be about 60 seconds (e.g., 45-65 seconds). By keeping the cure temperature less than about ⅓ of the melting temperature of the components being joined by epoxy 34, the likelihood of changing the material properties of the components during curing may be low.

Any type of clamp 28 known in the art may be used to hold the components of automobile 12 before, during, and/or after curing of epoxy 34. For example, clamp 28 may be a C-style clamp, a pipe clamp, a bar clamp, a spring clamp, a ratchet clamp, a cam clamp, a wheel clamp, or another type of clamp. Clamp 28 may be manually actuated or automatically actuated (e.g., by way of a motor in communication with controller 32), as desired.

Laser 30 may be configured to generate and direct one or more polarized light beams 36 toward joint 17. Laser 30 may include, for example, one or more of an Excimer laser, a Yb:tunstates laser, a CO2 laser, a Nd:YAG laser, a DPSS laser, or any other type of laser capable of heating epoxy 34 to its cure temperature. In the disclosed embodiment, laser 30 is configured to produce a light beam 36 having a circular or square cross-section, with a dimension (e.g., a diameter or width) that is less than an applied width of epoxy 34 within joint 17.

Controller 32 may embody a single processor or multiple processors that include a means for controlling an operation of manufacturing system 10. Numerous commercially available processors may perform the functions of controller 32. Controller 32 may include or be associated with a memory for storing data such as, for example, an operating condition; design limits; performance characteristics or specifications of epoxy 34, clamps 28, and laser 30; operational instructions; and corresponding quality parameters of joint 17. Various other known circuits may be associated with controller 32, including power supply circuitry, signal-conditioning circuitry, solenoid driver circuitry, communication circuitry, and other appropriate circuitry. Moreover, controller 32 may be capable of communicating with other components of manufacturing system 10 via either wired or wireless transmission.

Many different arrangements may be used to mount the different parts of manufacturing system 10. In the exemplary embodiment of FIG. 1, laser 30 is mounted to a robotic arm 38, which is configured to move laser 30 in multiple directions relative to automobile 12. In the depicted example, robotic arm 38 is a 6-axis arm regulated by controller 32 to translate laser 30 in three different directions and to also rotate laser 30 in three different directions. It is contemplated, however, that a different mechanism (e.g., a gantry or a hybrid arm/gantry mechanism) could be used to move laser 30 in the same or a different way, if desired. It is also contemplated that laser 30 may be fixedly mounted in a single position and/or orientation corresponding to a particular joint 17 to be created within automobile 12.

In some applications, multiple joints 17 may need to be created simultaneously within automobile 12. In these applications, one or more lasers 30 could be caused by controller 32 to create these joints 17. For example, a single laser 30 could be operated to create a single light beam 36, which is subsequently directed through a beam splitter 40. In this example, beam splitter 40 may split the single light beam 36 into any number of different light beams 36 that are each used to simultaneously create a different joint 17. It is contemplated that beam splitter 40 may be stationary (e.g., mounted to a fixed location within body station 14) or movable (e.g., mounted to laser 30, robotic arm 38, or a different arm or gantry mechanism). In another example, multiple lasers 30 mounted to the same or different robotic arms 38 may be operated to simultaneously create the different joints 17 using separate light beams 36.

In some embodiments, laser 30 may be operated by controller 32 to direct light beam(s) 36 to known locations where joint 17 should always be created. In these embodiments, placement of automobile 12 may be tightly controlled, such that the corresponding components are clamped together at the known location prior to activation of laser 30. In other embodiments, however, the location of joint 17 may need to be detected after automobile 12 is moved into body station 14, such that laser 30 can be appropriately aimed and controlled. In these embodiments, a locator 42 may be used to locate the intersection of the automobile components, such that joint 17 may be appropriately created. Locator 42 could be, for example, a camera configured to visually detect the joint location, an RFID reader configured to detect the presence of a corresponding tag placed at the joint location, a proximity sensor configured to interact with automobile 12 and/or fabrication platform 16, and/or another type of device known in the art. Signals indicative of the detected location may then be directed from locator 42 to controller 32 for further processing. Locator 42 could be stationary or mobile, and mounted together with laser 30 (e.g., on robotic arm 38) or mounted separately, as desired.

FIG. 2 is a perspective illustration of an exemplary joint 17 that may be produced by manufacturing system 10 of FIG. 1. In this example, each of body panels 18 and 20 are formed to have an integral flange 44 located at an outer periphery. Flanges 44 may be configured to face other, with the layer of epoxy 34 sandwiched therebetween. The layer of epoxy 34 may have a width about the same or less than a width w of flanges 44, such that epoxy 34 does not extend out of the resulting joint 17. In some embodiments, the width w of each flange 44 is about 5 mm or less. Clamp 28 may be configured to engage flanges 44 from opposing sides and exert an inward force on each of components 18 and 20. Clamp 28 may push flanges 44 toward each other until an internal space having a thickness t is created. In one embodiment, thickness t is about 0.25 mm (e.g., 0.2-0.3 mm). The thickness t may be a distance of separation between flanges 44 that remains substantially constant along a length of joint 17. One skilled in the art would understand that the thickness t and/or distance of separation may include variations within 5%.

Light beam 36 may be directed against an outer surface (i.e., a surface not in contact with epoxy 34) of one of flanges 44, thereby heating epoxy 34 by way of conduction through the impinged flange 44. In some applications, an entire length of flanges 44 may not need to be joined. That is, epoxy 34 may be applied at spaced-apart intervals, and light beam 36 may be used to “skip-weld” flanges 44 to each other at the intervals. In these applications, light beam 36 may be directed to imping flange 44 at a location immediately adjacent clamp 28, and move away from clamp 28 to create a joint 17 having a maximum length L. In some embodiments, length L is about 70 mm.

Light beam 36 may be directed against the one of the abutting flanges 44 having a greater capacity to conduct heat into epoxy 34. In some applications, this may mean that light beam 36 is directed to impinge a thinner of the two flanges 44. In other applications, this may mean that light beam 36 is directed to impinge the flange 44 fabricated from a material having a greater coefficient of thermal conductivity. Other strategies may also be employed.

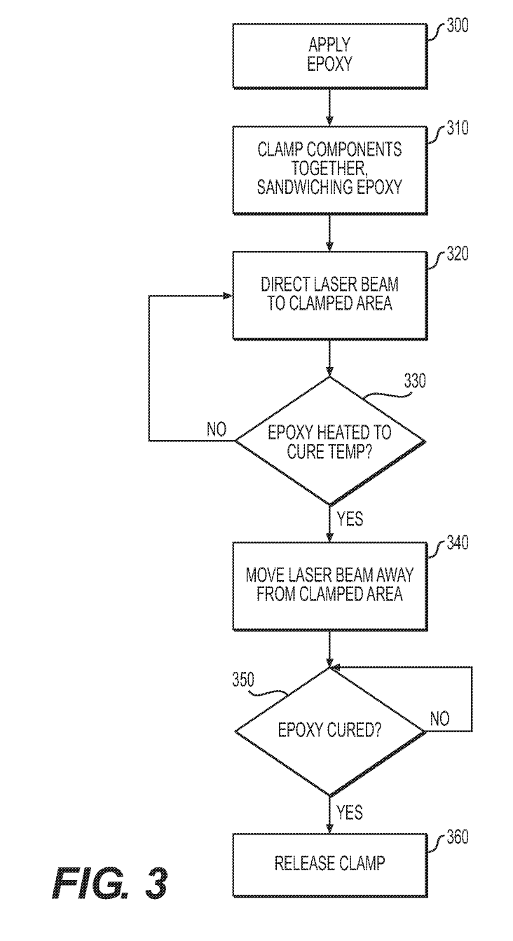

FIG. 3 provides a flowchart illustrating an exemplary method of manufacture that may be performed by manufacturing system 10 of FIG. 1. As shown in this flowchart, the method may begin with epoxy 34 being applied to flange 44 of one or both of body panels 18 and 20 (Step 300). As described above, epoxy 34 may be manually and/or automatically applied as a thin layer of paste to inward oriented faces of flanges 44 via dispenser 26. Thereafter, flanges 44 may be pushed together via clamps 28, thereby sandwiching the layer of epoxy 34 (Step 310). Clamps 28 may be caused to push flanges 44 toward each other until the space between flanges 44 has the specified thickness t.

After clamps 28 are in place on flanges 44 of body panels 18 and 20, controller 32 may cause laser 30 to generate light beam 36 at the clamped area (Step 320). As describe above, only a single light beam 36 may need to impinge only an outer surface of one of flanges 44 in order to sufficiently heat epoxy 34 to the cure temperature. It is contemplated, however, that multiple light beams 36 could be simultaneously directed at both flanges 44 from opposing or alternating sides, if desired. Controller 32 may continue to cause laser 30 to heat a specific section of flange(s) 44 until controller 32 determines that the temperature of epoxy 34 within that section has been maintained above the cure temperature for at least the specified cure time (Step 330). When skip-welding is required, light beam 36 may begin proximal clamp 28 and be caused to move in a length direction of flanges 44 away from clamp 28 for the specified length L (Step 340). Thereafter, clamps 28 may be released (Step 350).

It will be apparent to those skilled in the art that various modifications and variations can be made to the disclosed manufacturing system and related method. Other embodiments will be apparent to those skilled in the art from consideration of the specification and practice of the disclosed manufacturing system and related method. It is intended that the specification and examples be considered as exemplary only, with a true scope being indicated by the following claims and their equivalents.

What is claimed is:

1. A manufacturing system, comprising:
at least one clamp configured to maintain a distance of separation between a first component and a second component for an epoxy provided therein;
a laser; and
a controller in communication with the laser and configured to cause the laser to direct at least one light beam against one of the first and second components to heat the epoxy by conduction to a cure temperature.

2. The manufacturing system of claim 1, wherein the distance of separation between the first and second components is about 0.25 mm.

3. The manufacturing system of claim 1, wherein the cure temperature is less than about one-third of a lowest melting temperature of the first and second components.

4. The manufacturing system of claim 1, wherein the controller is further configured to cause the laser, via the at least one light beam, to maintain a temperature of the epoxy at the cure temperature for a cure time.

5. The manufacturing system of claim 4, wherein the cure time is less than about 60 seconds.

6. The manufacturing system of claim 1, wherein the controller is configured to cause the laser to direct the at least one light beam against the one of the first and second components at spaced apart intervals along a joint formed for coupling the first and second components to one another.

7. The manufacturing system of claim 6, wherein each of the spaced apart intervals is located immediately adjacent the at least one clamp.

8. The manufacturing system of claim 6, further including a locator configured to detect a location on the joint, wherein the controller is in communication with the locator and configured to guide the laser based on the location on the joint detected by the locator.

9. The manufacturing system of claim 8, wherein the locator includes a camera.

10. The manufacturing system of claim 1, further including a dispenser configured to dispense the epoxy onto at least one of the first and second components before the first and second components are brought together by the at least one clamp.

11. The manufacturing system of claim 1, further including a beam splitter configured to divide the at least one light beam into multiple light beams.

12. A method of manufacture, comprising:
providing a quantity of epoxy in a space between a first component and a second component; and
directing a light beam against at least one of the first and second components to heat the epoxy by conduction to a cure temperature.

13. The method of claim 12, further including maintaining, via the light beam, a temperature of the epoxy at the cure temperature for a cure time.

14. The method of claim 12, wherein directing the light beam against the at least one of the first and second components includes directing the light beam against an outer surface opposite an inner surface that contacts the epoxy.

15. The method of claim 14, wherein directing the light beam against the at least one of the first and second components includes directing the light beam against a thinner one of the first and second components.

16. The method of claim 14, wherein directing the light beam against the at least one of the first and second components includes directing the light beam against the one of the first and second components fabricated from a material having a greater coefficient of thermal conductivity.

17. The method of claim 12, further including clamping the first component to the second component to maintain a substantially constant distance of separation between the first and second components.

18. The method of claim 17, wherein the substantially constant distance of separation is about 0.25 mm.

19. The method of claim 12, wherein the cure temperature is less than about one-third of a lowest melting temperature of the first and second components.

20. An automotive body, comprising:
a first body panel having a first flange;
at least one of a second body panel and a frame having a second flange; and
a heat-cured epoxy sandwiched between the first and second flanges,
wherein the first and second flanges are connected to each other by only the heat-cured epoxy.
